(19) United States
(12) Patent Application Publication
(10) Pub. No.: US 2016/0339660 A1
(43) Pub. Date: Nov. 24, 2016

(54) METHOD FOR RETREADING A TIRE CASING USING A HEATING BAND

(71) Applicants: Gregory MARCET, CLERMONT-FERRAND (FR); Henri HINC, CLERMONT-FERRAND (FR); Jose MERINO LOPEZ, CLERMONT-FERRAND (FR); Mathieu DELBOS, CLERMONT-FERRAND (FR)

(72) Inventors: Gregory MARCET, CLERMONT-FERRAND (FR); Henri HINC, CLERMONT-FERRAND (FR); Jose MERINO LOPEZ, CLERMONT-FERRAND (FR); Mathieu DELBOS, CLERMONT-FERRAND (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 15/106,182

(22) PCT Filed: Dec. 18, 2014
(86) PCT No.: PCT/FR2014/053411

§ 371 Date: Jun. 17, 2016

(30) Foreign Application Priority Data
Dec. 23, 2013 (FR) 1363448

(51) Int. Cl. B29D 30/54; B29C 65/34; B29C 65/36; B29D 30/66

(52) U.S. Cl. CPC B29D 30/54; B29D 30/66; B29C 65/342; B29C 65/348; B29C 65/362; B29C 65/368; B29D 2030/544; B29D 2030/548; B29K 2021/003

(57) ABSTRACT

In a method for manufacturing a tire casing, at least one electrically conductive wire forms turns that are centered on a main axis of the casing. Additionally, a bonding layer is incorporated into the casing.

### BACKGROUND

1. Field of the Invention

The disclosure relates to the retreading of tires.

2. Related Art

The retreading operation conventionally consists in removing the worn tread from a tire casing in order to replace it with a new tread. To this end, it is known practice to provide the tire with a hot-melt bonding layer that bonds the tread to the carcass. With a view to retreading, this layer is applied to a tire carcass. Next, a tread that is compatible with use on a wheel is laid. Next, this layer is heated to a predetermined temperature that is characteristic of the material and then it is allowed to cool. On cooling, the layer ensures the adhesion of the tread to the carcass. The heating operation can be carried out before assembly, for example by infrared or forced convection, or after assembly, for example by contact conduction, electrical conduction, forced convection, high-frequency or microwave induction.

During heating, pressure should be applied to the tread in order to press the bonding layer firmly between the tread and the carcass. This pressing means should be compatible with the heating means used, that is to say should not impair the conduction or convection of the heat flow or any electrical connector which emerges from the heating means integrated into the tire, or should be transparent to electromagnetic radiation, to high-frequency or microwave induction.

### SUMMARY

The aim of the disclosure is to make it easier to heat and pressurize the hot-melt bonding layer.

To this end, according to the disclosure, a method for manufacturing a tire casing is provided, in which at least one electrically conductive wire forming turns centered on a main bonding axis of the casing, and a layer are disposed inside the casing.

Thus, the wire allows the bonding layer to be heated by the Joule effect in order to retread the casing. In addition, the orientation of the wire ensures the reinforcement of the casing and allows the part which bears it to withstand pressurization better, and allows the hot-melt layer to be pressurized. The wire also has a role of mechanical hooping in the casing during rolling.

Advantageously, the wire is metal.

Preferably, the bonding layer comprises a hot-melt material, preferably a thermoplastic elastomer.

According to one embodiment, a carcass of the casing is provided with a reinforcement ply separate from the wire.

Thus, the casing has a safety reinforcement ply in addition to the heating wire. The ply is for example a ply at an angle of preferably between 0 and 20°, and more preferably between 0 and 10°, with respect to the longitudinal direction, expressed in absolute terms. This makes it possible to minimize the consequences of failure of the bonding layer. Specifically, in the absence of a reinforcement ply, if the tread bears the wire on its internal surface and detaches from the rest of the casing, the latter is then no longer hooped.

According to one embodiment, the wire is incorporated into a tread of the casing.

The wire is then very close to the hot-melt bonding layer, thereby making it possible to locally heat the latter and prevent undesirable recuring or overcuring of the rubbers of the various parts of the casing.

According to another embodiment, the wire is incorporated into the bonding layer.

Thus, the heating time is reduced since it is not necessary for the heat to diffuse through the rubber. In addition, the temperature which the wire should reach in order to soften the bonding layer is lower and the heating time is shorter than if it were positioned in the rubber, outside the layer.

Also provided according to the disclosure is a tire casing, which comprises, inside the casing, at least one electrically conductive wire forming turns centered on a main axis of the casing, and a bonding layer comprising a hot-melt material.

Also provided according to the disclosure is a method for retreading a tire casing, wherein a bonding layer is heated by means of a wire through which an electric current passes, the wire extending inside the casing and forming turns centered on a main axis of the casing.

The softening of the bonding layer is thus brought about.

In one embodiment, a carcass of the casing is mounted on a rim.

In one embodiment, a tread is fitted on a carcass, the wire being incorporated into said tread.

Advantageously, the carcass is inflated.

Thus, the inflation of the carcass brings about an increase in its volume. The carcass and the tread firmly press the bonding layer between one another.

Preferably, the carcass is kept in the inflated state while the casing is cooled.

By allowing the bonding layer to cool in this way, it creates the adhesion between these two parts and applies pressure to an outer surface of the casing towards the inside thereof.

The bonding layer is pressurized in this way notably if the carcass comprises a reinforcement ply.

Preferably, the pressure outside the casing is maintained while the casing is cooled.

Also provided according to the disclosure is a tire tread which is in the form of a closed ring, does not have a casing carcass and which comprises at least one electrically conductive wire forming turns centered on a main axis of the tread.

This intermediate product is suitable for implementing the method of the disclosure.

Finally, a tire casing which has undergone a retreading operation according to the disclosure is provided according to the disclosure.

### BRIEF DESCRIPTION OF THE DRAWINGS

Several embodiments of the disclosure will now be presented with reference to the appended drawings, in which

FIG. 1 is a view in axial section of a tire casing according to one embodiment of the disclosure,

FIG. 2 is a view on a larger scale of part of the casing in FIG. 1,

FIG. 3 is a view similar to that in FIG. 2 according to another embodiment, and

FIG. 4 is a view in axial section of a tire casing according to another embodiment of the disclosure.

### DETAILED DESCRIPTION

An embodiment of the disclosure, which consists in the manufacture of a wheel tire casing, will be described.

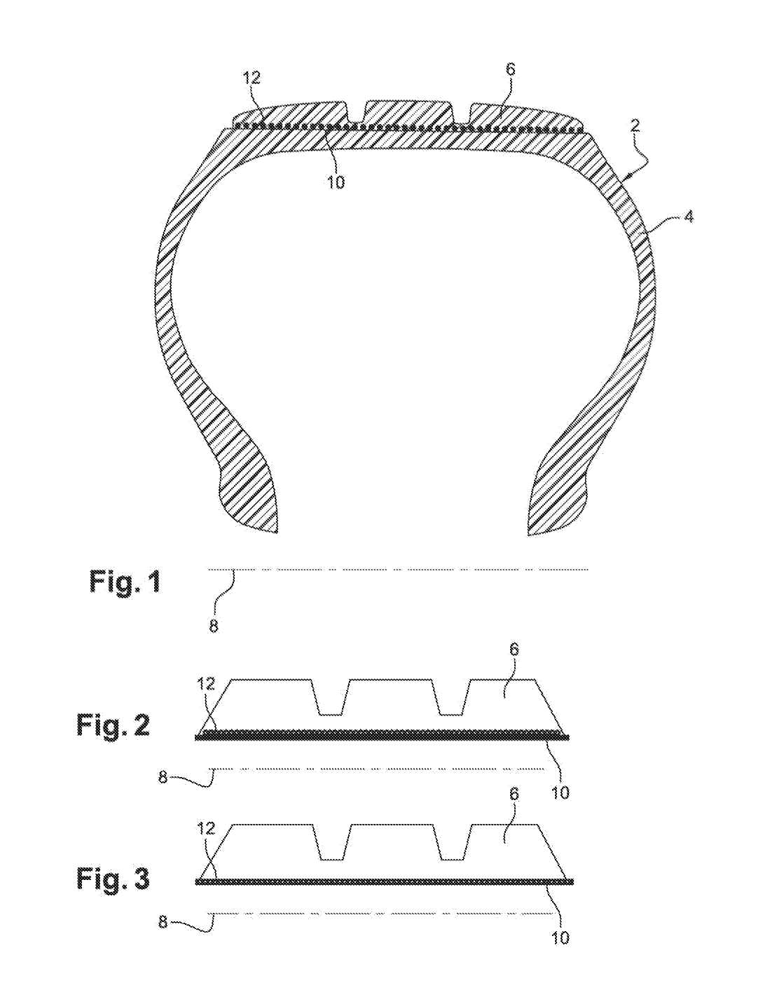

With reference to FIG. 1, a green form of casing 2 comprises a green form of carcass 4 made of raw rubber and a green form of tread 6 made of raw rubber in the form of a closed ring carried by the carcass on the side thereof that is furthest from a main axis 8 of the casing. The green form of casing also comprises a bonding layer 10 interposed between the carcass 4 and the tread 6 in the radial direction with respect to the axis 8. In this case, it is a layer made of a hot-melt material. A hot-melt material is understood to be a material that is able to soften when it is subjected to heating in order to be brought to a predetermined temperature that is characteristic of said hot-melt material, known as the softening temperature. For example, such a hot-melt material can be chosen from thermoplastic elastomers such as SBS (styrene-butadiene-styrene) or SIS (styrene-isoprene-styrene). For the purposes of the disclosure, reference is made to a hot-melt material that is capable of softening at a temperature of between 140° C. and 200° C.

With reference to FIG. 2, an electrically conductive wire 12 made of inextensible material is incorporated into the tread 6. This wire is disposed such that it forms turns centered on the main axis 8 of the casing. The turns cover the entire width and the entire circumference of the casing and form a single-layer ply.

Next, the assembly is cured, in an oven and in a mould for example, until the rubber is vulcanized. In this way, a tire casing is obtained.

The casing is then able to be mounted on a vehicle.

The implementation of a second method, which consists in retreading such a tire casing will now be described. This method is thus applied to a casing 2 that results from the above-described method. It is assumed that the tread 6 has to be removed from the casing, for example because it has a level of wear incompatible with use on a wheel.

For this purpose, in order to heat the wire 12, the two ends of the latter are connected to a power source which is not illustrated here. To this end, provision can be made for the two ends to protrude slightly from a sidewall of the casing in order to facilitate this connection, or the tread is cut into in order to access the ends. The wire through which the current passes thus heats the bonding layer 10 by the Joule effect. It will be readily understood that the pattern exhibited by the wire allows the current to pass through all of the latter, thereby making its heating virtually uniform.

Once the predetermined temperature that depends on the bonding layer has been reached, the latter melts and loses its adhesive property. It is thus possible to grasp the tread and separate it entirely from the rest of the casing by peeling.

Next, the casing is retreaded. For this purpose, it is necessary to lay on the casing a new tread made of raw rubber, in the form of a closed ring, which is either in the new state or has a level of wear compatible with its use on a wheel.

To this end, the carcass 4 is mounted on a rim which is not illustrated here, and then the bonding layer 10 and a new tread 6 made of raw rubber and in the form of a closed ring is applied on top. A wire 12 is incorporated into the tread, as above.

It is then necessary to firmly press the bonding layer between the tread and the carcass with a view to heating it. For this, it is sufficient to inflate the carcass to a sufficiently high pressure, for example greater than 2 bar, i.e. 2×10⁵ Pa, or even greater than 3 bar, i.e. 3×10⁵ Pa. Given that the wire is inextensible, it constrains the carcass to a fixed diameter. As a result, the bonding layer is firmly held between the carcass and the tread by virtue of the inflation pressure for the one part and the wire for the other.

Once the bonding layer is pressurized, a current is passed through the wire, as above, with the aim of heating it by the Joule effect, to a temperature greater than the predetermined characteristic temperature of the material of which the layer is made. The latter then softens. It is advantageous to maintain the relative position of the tread with respect to the carcass with the aid of a device (not illustrated) which fixes it in place and thus prevents any lateral movement of the tread.

By then allowing the bonding layer to cool, the adhesion of the tread to the carcass is created.

It is then possible to deflate the casing and remove it from the rim.

The casing can then be mounted on a wheel.

During rolling, the ply also has a role of hooping and reinforcement.

In a variant of the disclosure, illustrated in FIG. 3, the methods described above are implemented in an identical manner with the only difference being that the wire 12 is not incorporated into the tread 6 but into the bonding layer 10. This arrangement has the advantage of reducing the heating time for the bonding layer, since the heat does not have to diffuse through the rubber, and the temperature that the wire has to reach with the aim of softening the bonding layer. In addition, it is not necessary to install a new wire after the worn tread has been peeled, since the bonding layer held by the wire remains in place on the carcass.

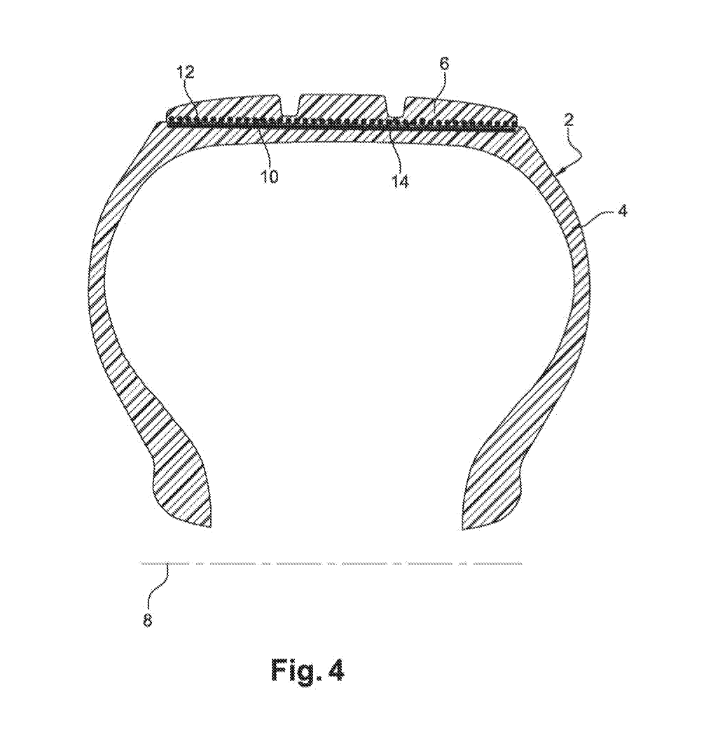

In another variant of the disclosure, illustrated in FIG. 4, the crown part of the carcass is provided with a reinforcement ply 14, separate from the wire 12, which has a role of mechanical hooping of the casing during rolling. By way of example, this ply can comprise reinforcement elements that form a small angle (less than 6°) with the longitudinal direction, such as metal cords (made of steel for example) or textile cords (made of polyester, nylon, rayon, polyethylene naphthalate (PEN) or aramid for example) embedded in a matrix of non-hot-melt rubber compound. The sum of the resistances of the ply 14 and of the wire 12 is greater than or equal to that of a conventional ply. For a tire of dimensions 205/55 R16, the sum of the resistances is greater than 150 daN·cm⁻¹, i.e. 1.5×10⁵ N·m⁻¹, and preferably greater than 200 daN·cm⁻¹, i.e. 2×10⁵ N·m⁻¹. The resistance of the ply 14 alone is preferably less than 60% of that of a conventional hooping ply, and should be less than 120 daN·cm⁻¹, i.e. 1.2×10⁵N·m⁻¹.

With the presence of the reinforcement ply 14, the methods described above can be implemented virtually in an identical manner, only the step of pressurizing the bonding layer 10 being different.

Specifically, in this embodiment, it is the reinforcement ply 14 which delimits the expansion of the carcass, and no longer the wire 12. Consequently, the stress transmitted is insufficient to pressurize the bonding layer. In order to remedy this problem, a pressure of preferably greater than 1 bar, i.e. 1×10⁵ Pa, is applied to the tread 6 towards the inside of the casing 2, for example by means of a micro-chamber or an autoclave, or by winding. The bonding layer is then firmly held between the carcass 4 and the tread 6 by virtue of the inflation pressure for the one part and the external pressure for the other. It is subsequently possible to follow the same steps as those described above.

Of course, numerous modifications may be made to the disclosure without departing from the scope thereof.

The bonding layer can comprise a hot-melt material other than a thermoplastic elastomer.

For example, the bonding layer can be a bonding rubber, in which case it is not necessary to cool it under pressure after it has been heated with a view to retreading.

The carcass can have any other architecture and other dimensions.

The wire can be replaced by a plurality of wires.

1. A method of manufacturing a tire casing, comprising the steps of:
forming turns centered on a main axis (8) of the casing with at least one electrically conductive wire, and
disposing a bonding layer inside the casing.

2. The method as set forth in claim 1, wherein the wire is metal.

3. The method as set forth in claim 1, wherein the bonding layer comprises a hot-melt material of a thermoplastic elastomer.

4. The method as set forth in claim 1, wherein a carcass of the casing is provided with a reinforcement ply separate from the wire.

5. The method as set forth in claim 1, wherein the wire is incorporated into a tread (6) of the casing.

6. The method as set forth in claim 1, wherein the wire is incorporated into the bonding layer.

7. A tire casing, comprising;
at least one wire forming turns centred on a main axis of the casing, and
a bonding layer comprising a hot-melt material.

8. A method of retreading a tire casing, comprising the steps of;
heating a bonding layer by means of a wire through which an electric current passes and wherein the wire extends inside the casing and forms turns centered on a main axis of the casing.

9. The method as set forth in claim 8, wherein a carcass of the casing is mounted on a rim.

10. The method as set forth in claim 8, wherein a tread is fitted on a carcass and the wire is incorporated into the tread.

11. The method as set forth in claim 9, wherein the carcass is inflated.

12. The method as set forth in claim 8, wherein the carcass is kept in the inflated state while the casing is cooled.

13. The method as set forth in claim 8, wherein pressure is applied to an outer surface of the casing towards the inside thereof.

14. The method as set forth in claim 13, wherein the pressure outside the casing is maintained while the casing is cooled.

15. A tire casing that it has undergone a retreading method according to claim 8.

16. A tread which is in the form of a closed ring and does not have a casing carcass and wherein at least one electrically conductive wire forms turns centered on a main axis of the tread.
